(19) United States
(12) Patent Application Publication
(10) Pub. No.: US 2025/0142091 A1
(43) Pub. Date: May 1, 2025

(54) METHOD AND SYSTEM FOR USING PHYSICAL TOY BLOCKS TO PREFORM CODING TASKS

(71) Applicant: THE GOVERNORS OF THE UNIVERSITY OF ALBERTA, Edmonton (CA)

(72) Inventors: Rafiq Ahmad, Edmonton (CA); Patrick Hung, Stouffville (CA); Farkhund Iqbal, Abu Dhabi (AE); Jennifer Alejandra Cardenas Castaneda, Edmonton (CA)

(21) Appl. No.: 18/927,536

(22) Filed: Oct. 25, 2024

Related U.S. Application Data
(60) Provisional application No. 63/593,839, filed on Oct. 27, 2023.

(51) Int. Cl. H04N 19/176; H04N 19/70

(52) U.S. Cl. CPC H04N 19/176; H04N 19/70

(57) ABSTRACT

Embodiments herein generally relate to a method and system using physical toy blocks to perform (e.g., execute) coding tasks. In some examples, the method for performing coding tasks using physical toy blocks involves: capturing one or more images of an assembled arrangement of the toy blocks; analyzing the images to determine one or more arrangement features; based on the determined arrangement features, determining a code structure associated with the block arrangement; determining if the code structure satisfies one or more criteria, associated with a coding task; and if so, generating an output indicating the coding task is completed.

### CROSS-REFERENCE TO RELATED APPLICATION(S)

The present application claims priority to, and benefit of U.S. Provisional Patent Application No. 63/593,839 titled “METHOD AND SYSTEM FOR USING PHYSICAL TOY BLOCKS TO PERFORM CODING TASKS”, filed on Oct. 27, 2023, the entire contents of which are incorporated herein by reference.

### FIELD

The present disclosure generally relates to computer program coding, and more particularly, to a method and system using physical toy blocks to perform (e.g., execute) coding tasks. The disclosed embodiments can function, in some cases, as an educative tool for teaching coding concepts to visually impaired persons (e.g., children).

### BACKGROUND

Computer programming is increasingly recognized as a crucial skill that children should acquire, and schools should impart. The significance of teaching computer programming in primary schools has received growing attention in recent years, and particularly from numerous prominent corporations. The key drivers for this growing attention include the immense economic potential of learning to code, as well as the growing recognition of programming as a potential route for youth participation.

To that end, toys that encourage children's computational thinking have been designed and marketed to introduce coding to children at a young age. For visually impaired children, however, there are few available programming resources (e.g., toys). These children require hands-on, tactile experiences that are specifically tailored to their unique needs and abilities. The current market offerings severely lack diversity and variety, with the vast majority of educational resources being geared toward sighted children.

### SUMMARY OF VARIOUS EMBODIMENTS

In at least one aspect, there is provided a method for performing coding tasks using physical toy blocks, comprising: capturing at least one image of an assembled arrangement of the toy blocks, wherein each toy block comprises a block type associated with a programming code concept; analyzing the at least one image to determine one or more block arrangement features; based on the determined arrangement features, determining a coding structure associated with the block arrangement; determining if the coding structure satisfies one or more task completion criteria, associated with a coding task; and if so, generating an output indicating the coding task is completed.

In another broad aspect, there is provided an interactive system for performing coding tasks using physical toy blocks, comprising: a plurality of toy blocks, each toy block being of a block type that is associated with a programming code concept; an imaging sensor; a non-visual interface for communicating an output; and at least one processor coupled to the imaging sensor and configured for: capturing, using the imaging sensor, at least one image of an assembled arrangement of the toy blocks in the plurality of toy blocks, analyzing the at least one image to determine one or more block arrangement features; based on the determined arrangement features, determining a coding structure associated with the block arrangement; determining if the coding structure satisfies one or more task completion criteria, associated with a coding task; and if so, generating an output indicating the coding task is completed via the non-visual interface.

In some examples, analyzing of the at least one image is performed using a trained object detection model.

In some examples, the trained object detection model is a trained MobileNetSSD model.

In some examples, the programming code concept comprises one or more syntax elements of a logic computational instruction, and the coding structure comprises the logic computational instruction.

In some examples, the programming code concept comprises one or more of a numerical value, a variable, a data type, an operator, a control flow statement or an action.

In some examples, the block arrangement features include one or more of (i) the block types in the arrangement; (ii) block attributes of each block type; and (iii) coupling configuration of the toy blocks.

In some examples, a coding task comprises instructions to physically arrange the toy blocks in a target assembled configuration corresponding to a target coding structure.

In some examples, determining if the task completion criteria are satisfied comprises determining that the coding structure associated with the block arrangement, matches the target coding structure.

In some examples, the output comprises non-visual feedback.

In some examples, the non-visual feedback comprises an audio prompt or a haptic prompt.

Other features and advantages of the present application will become apparent from the following detailed description taken together with the accompanying drawings. It should be understood, however, that the detailed description and the specific examples, while indicating preferred embodiments of the application, are given by way of illustration only, since various changes and modifications within the spirit and scope of the application will become apparent to those skilled in the art from this detailed description.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and which are now described. The drawings are not intended to limit the scope of the teachings described herein.

FIG. 1 is an example environment for performing coding tasks using physical toy blocks;

FIGS. 2 to 6 show various example toy blocks that can be used for performing coding tasks;

FIG. 7A is an example method for performing coding tasks using physical toy blocks;

FIG. 7B is an example method for applying a trained objection detection model, in accordance with teachings provided herein;

FIG. 7C is an example method for training an objection detection model, for application in the method of FIG. 7B;

FIG. 8 is an image of a coding block being detected using a trained object detection model;

FIG. 9 is an example hardware configuration for an example user device; and

FIG. 10 is an example system for performing coding tasks using physical toy blocks.

Further aspects and features of the example embodiments described herein will appear from the following description taken together with the accompanying drawings.

### DETAILED DESCRIPTION OF THE EMBODIMENTS

Mobile technologies are increasingly employed as educational tools for literacy, including for teaching reading and writing. Young children can also learn to code using these tools and technology, as a form of learning “computer” literacy.

There are, however, few programming resources and possibilities available for visually impaired children, and that do not rely heavily on visual components. More generally, visually impaired children are often not afforded similar opportunities, to sighted children, to learn computational thinking. This leads to the denial of their right to an education, which has long-term effects on their academic performance, employment chances, and human, social, and economic development. An inclusive strategy is crucial to making sure that programming education is accessible to all kids, including those who have visual impairments.

In view of the foregoing, embodiments herein relate to an innovative approach to computer programming learning for visually impaired persons (e.g., children), through AI-powered audio prompts and games. The disclosed embodiments utilize tangible, physical blocks to represent different code portions. The user is asked to arrange the blocks to perform a coding task. Once arranged, the blocks are imaged and recognized in real-time, or near real-time, through computer vision object detection integrated within a computing platform. A computer software then analyzes the image of the arranged blocks, to determine whether they are arranged to solve the coding task.

### I. General Overview

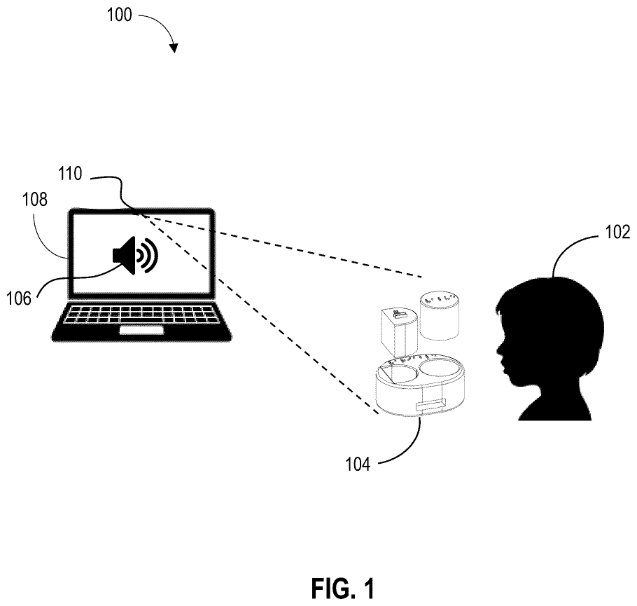

FIG. 1 shows an example environment (100) for an interactive system of using physical toy blocks for coding, in accordance with disclosed embodiments.

In one example application, environment (100) provides a comprehensive and interactive environment for visually impaired users to connect with and learn program coding.

As shown, environment (100) includes a user (102), who is learning how to program code. In some examples, user (102) is a visually impaired person, e.g., a visually impaired child.

User (102) is provided with various physical toy blocks (104) (also referred to herein as “coding blocks”). Each block (104) has a distinct meaning and function to introduce and reinforce various programming concepts. That is, each physical block (104) can correspond to, and is otherwise associated with, a unique programming code concept. For instance, blocks (104) can represent different logic operations.

As detailed herein, blocks (104) are connected (e.g., joined and/or coupled) to express more complex coding concepts. For example, blocks (104) are coupled to represent more complex coding structures (e.g., an if-else operation).

Environment (100) also includes a user device (108). User device (108) is any computing device, e.g., portable or non-portable, including a laptop, desktop computer, mobile phone, tablet, or any smart device.

User device (108) hosts a learning software, which can guide the user (102) through using the coding blocks (104).

In at least one example, the learning software generates coding tasks for the user (102) to complete (e.g., solve), via the coding blocks (104). For visually impaired users, the coding tasks are generated in the form of audio prompts (106). User (102) can complete the coding tasks by arranging and/or coupling the blocks (104).

By way of illustrative example, a coding task can involve asking the user to represent a particular operation (e.g., an if-else statement) via coding blocks (104). In some examples, the coding tasks are in the form of games and missions, that allow for a more interactive experience. For instance, the learning software may generate a plurality of successive audio prompts (106), each requiring the user to solve a new riddle by correctly arranging the blocks (104).

Once the user (102) has arranged the blocks (104) to complete (e.g., perform) the task, the arranged blocks (104) are presented within a view of an imaging sensor (110) (e.g., camera). Imaging sensor (110) is associated with the user device (108), or otherwise coupled (directly or in-directly) to user device (108).

Imaging sensor (110) captures an image of the arranged blocks. The learning software then analyzes the captured image to determine whether the blocks are arranged correctly to satisfy the coding task. To that end, the images may be analyzed in real-time, or near real-time. The images can be analyzed, for example, by a trained object detection model, hosted on the user device (108) to identify each block.

In some cases, once the images are analyzed, the user (102) is informed through a non-visual feedback output, e.g., audio or haptic feedback, whether the correct answer was achieved, for the particular coding task.

It is believed that the disclosed combination of non-visual prompts, such as audio prompts, and image analysis, allows for a feedback type learning for visually impaired persons. This feedback learning can be suited to teach visually impaired users various computer coding and logic concepts. Various programming concepts can be taught by targeting hearing, as well as the sense of tactile touch of the physical toy blocks, thereby providing an immersive and interactive teaching environment.

### II. Example Toy Coding Blocks

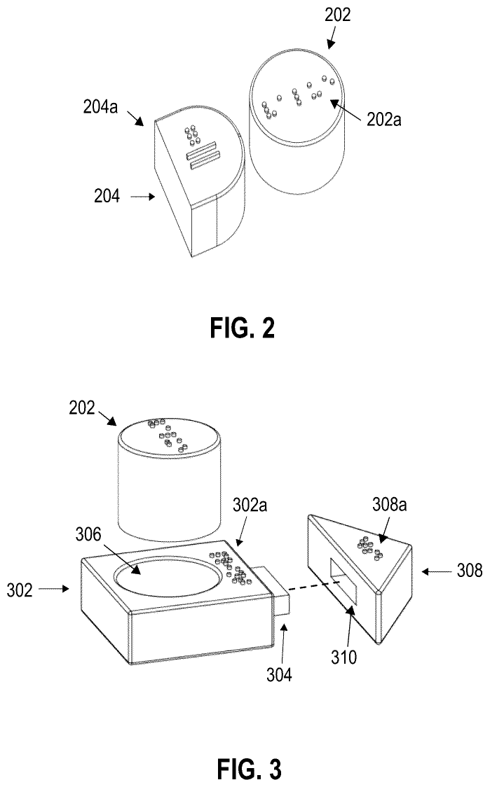

FIGS. 2 to 6 exemplify various physical toy coding blocks (104) employed in disclosed embodiments. These figures also illustrate how these coding blocks (104) are coupled together to represent more complex coding structures, and constructs.

As shown, different blocks (104) can be used to represent different programming code concepts (or, programming code logic elements). In some examples, a kit is provided that includes a plurality of blocks representing various programming code concepts.

As used herein, a “programming code concept” refers to one or more syntax elements relating to at least one of structure and function of a logic computational instruction. Programming code concepts therefore form a part of, and are combined to form, computational logical instructions. A computational logic instruction is any computer executable instruction having an input and output logic. This can include an assignment instruction (x=5), a conditional instruction (e.g., IF “x=5”, THEN print), a looping instruction, a functional call instruction and so forth as known in the art. A programming code concept, in turn, comprises any syntax element that is part of the logic instruction. For instance, this can include a numerical value (“5”), a variable (“x”), a data type, an operator (e.g., =, >), a control flow statement (e.g., if, then, else) and/or action (e.g., print, value).

By way of example, FIG. 2 shows a cylindrical value block (202), that can represent a numerical value, and includes the word “value” written in Braille (202a) on the top surface of the block. As explained herein, the value block (202) can be coupled to, and stored inside of the variable, if, and print blocks. The design of the value block (202) attempts to represent how it can be stored inside other blocks, and used for both string values and integer values.

Also illustrated is an operator block (204), which is a semi-cylindrical shape. The aim of the operator block (204) is to represent various operator functions (e.g., =; ==; !=; <; . >; <=; >=, AND). The operator block (204) provides specific meanings when placed inside both variable and if blocks, as explained below. The mathematical symbols used in the block is represented with a Nemeth Braille Code (204a), which represents mathematics in Braille.

FIG. 3 shows an example print block (302), which is square shaped block and has the word “print” written in Braille (302a) on top of the piece. It has one rectangular connector (304) on one side, which is the part that is used to be placed inside the blocking aperture of the variable, if, and else blocks, as explained below. The print block (302) also includes an aperture (306), which receives the value block (202). The purpose of this print block design is to place inside the final value that is to be shown by the code.

Also shown in FIG. 3, is an “else” block (308), which is represented as a triangular shape with the word “else” (308a) written in Braille. It includes an aperture (310) to receive the print block (302).

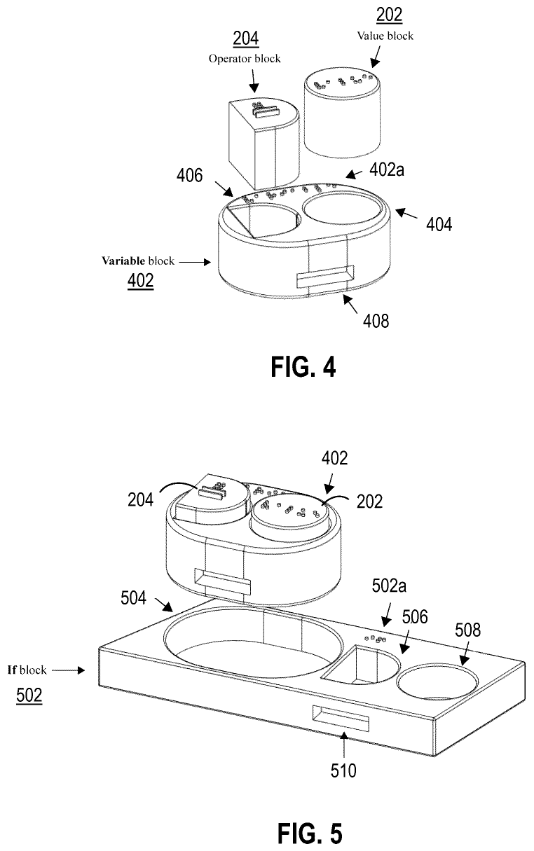

FIG. 4 exemplifies a variable block (402), which is represented in an oval shape form, and includes the word “variable” in Braille (402a). The variable block (402) contains two (2) apertures in the top part: (i) one aperture (404) to receive a value block (202), and (ii) the one aperture (406) to receive an operator block (204) (e.g., an equal (=) assignment operator). Variable block (402) also contains one rectangular aperture (408) on one side, to connect a print block (302) (e.g., FIG. 3). Variable block (402) allows users (102) to feel the dynamic of storing a value inside a variable, and then printing that value.

To that end, the variable and print blocks exemplify how multiple blocks can be coupled together to represent, or express, more complex coding structures. As used herein, a “coding structure” refers to a computational logical instruction (as defined above).

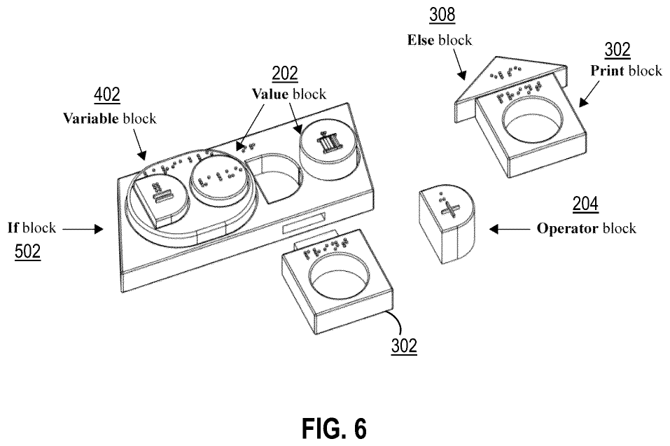

FIGS. 5 and 6 show an example “if” block (502), shaped in a rhomboid shape, and which also allows for representing more complex coding structure.

As shown, it contains three apertures in the top part: (i) a first aperture (504) to place the variable block (402), that will be considered within the condition, (ii) a second aperture (506) for receiving a comparison operator block (204), and (iii) a third aperture (508) to place the value module (202) inside, that is being used for the comparison within the condition. Additionally, it has a rectangular aperture (510) on one side for connecting to a print block (302). The dynamic of this design aims to provide a tactile comparison of the condition placed inside.

In view of the foregoing, examples herein provide for different toy blocks corresponding to different block types, wherein each block type is associated with a unique programming code concept.

To assist visually impaired persons to interact with the toy blocks, different block types may be associated with different physical block properties. As used herein “physical block properties” refers to any physical aspect of the block that is, for instance, detectable with physical tactile touch.

For instance, the physical block properties can include one or more of: (i) the block's geometric properties; (ii) physical indications on the block; (iii) block color scheme; and (iv) block apertures (e.g., number, size, shape and arrangement of apertures).

Different geometric properties can be used for different block types to allow for their easy identification by a visually impaired user via only tactile touch. For example, as explained above, different block types may have different 3D shapes.

Physical indications can comprise, for instance, Braille dots on the toy block surface. The Braille dots can indicate: (i) the block type (e.g., a logic operator block); and (ii) other block attributes. “Block attributes” generally include specifics about the block type. For instance, the numerical value associated with a value block (202), or the operator type associated with an operator block (204). In this manner, different block types (e.g., value or operator) have different associated block attributes. These block attributes are indicated by one or more physical indications on that block. While the illustrated examples show Braille used as the physical indication, the physical indication can comprise any other of physical indicia.

In at least one example, the physical indications are strategically disposed on the upper face of the toys blocks. This serves two functions, (i) as an orientation point so the learner can understand which face of the block needs to be up. This, in turn, ensures the blocks are properly assembled for object detection and recognition, as well as (ii) allowing learners to easily find and read the dots.

In still further examples, the block properties can also include different color schemes. For instance, high-contrast colors are selected to facilitate easy recognition by visually impaired learners with low vision, and thus improving the learning process.

Additionally, as explained above, certain block types can include one or more apertures. These apertures allow for coupling blocks to express more complex coding structures. In some examples, the apertures are sized and shaped to receive only specific block types. That is, the each aperture may have a cross-sectional shape that is complementary to the corresponding block type, that it is intended to receive.

### III. Example Method(s)

The following is a description of various example methods for performing coding tasks using physical toy blocks.

### (i.) Example Method for Performing Coding Tasks.

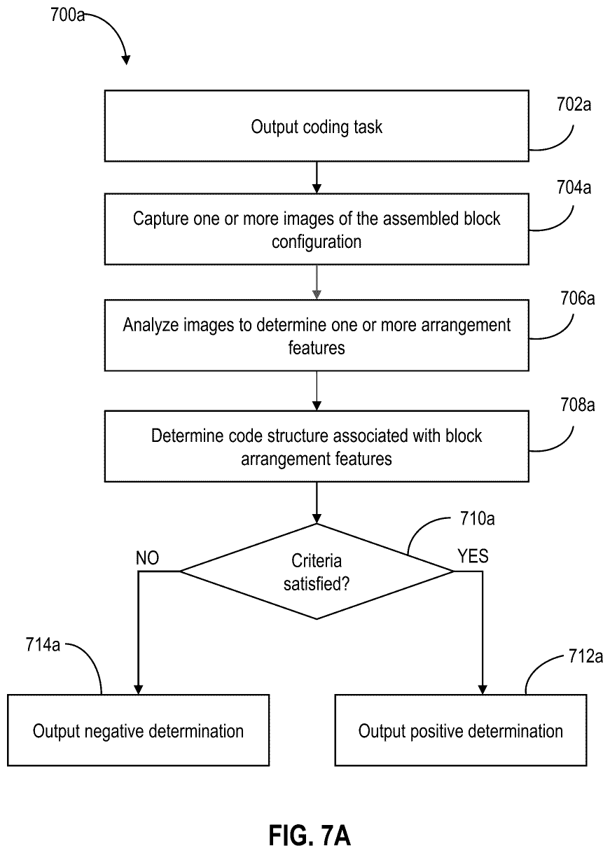

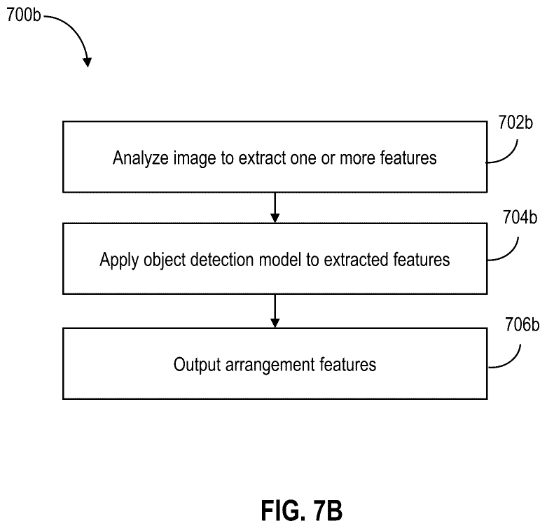

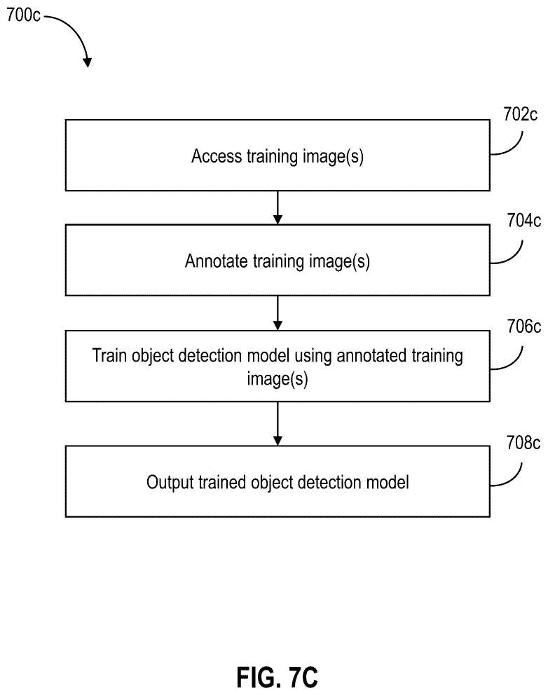

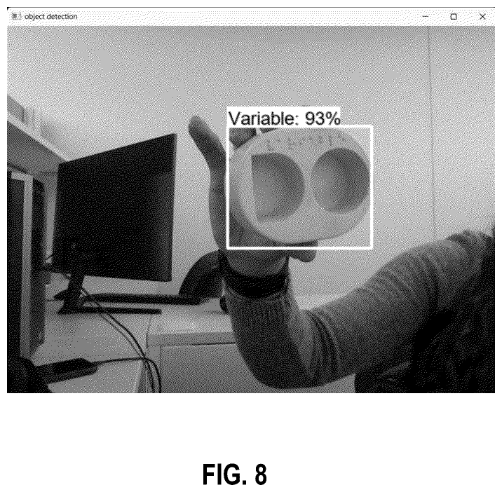

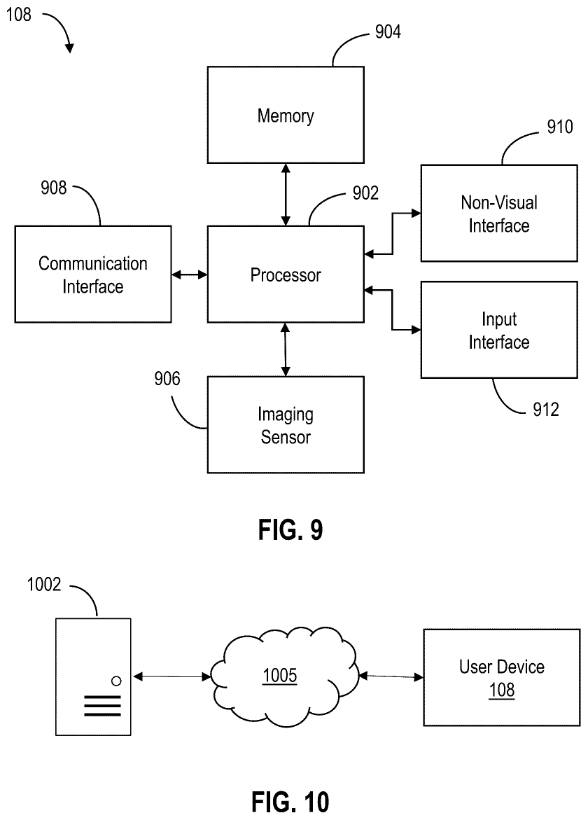

FIG. 7A shows an example method (700a) for performing coding tasks using physical toy blocks. In at least one example, method (700a) is executed by the processor (902), of the user device (108) (FIG. 9).

At (702a), the learning software, hosted on the user device (108), can output a coding task.

The coding task can comprise instructions that require the user to physically arrange the toy blocks (104) in a particular (or target) assembled block configuration. For example, a coding task can require the user to arrange the blocks (104) to represent a specific coding structure, such as an if-else statement. In other examples, the task is part of a game or mission, and presents a riddle (or problem), which the user solves by arranging blocks (104). In this case, a coding task can require the user to assembly blocks in an ordered sequence of different target assembly block configurations.

As used herein, an “assembled block configuration” is a coupling configuration between one or more toy blocks such that specific block types (e.g., with specific block attributes) are inserted into the apertures of other block types (e.g., with specific block attributes), or otherwise, receive other block types into their own apertures. The assembled block configuration may also involve disposing certain block types (e.g., with specific block attributes) adjacent each other.

The coding task can be output, at (702), in various manners. In at least one example, the output is any form of non-visual output. For instance, an audio prompt is generated by the user device (102), which audibly communicates the task to the user. This can allow visually impaired users to engage with the system. In other examples, this may include other types of tactile output feedback, such as a Braille display.

In response to receiving the coding task, the user will then attempt to complete the task by arranging the blocks (104) to form an assembled block configuration. This involves, for example, coupling together specific block types (e.g., inserting some block types into the apertures of other block types), or placing some block types adjacent other block types.

By way of illustrative example, an example practical coding task can comprise a “weather adventure”. In this example, the user is asked to locate a “print” block, and also assemble a “weather” variable. The user is then asked to assign a “weather condition” to a variable block (e.g., assigning the value “rainy”, to the variable “weather” block). The user then physically couples the variable block to the print block. Upon successful assembly, the game can audibly reproduces a corresponding sound (e.g., rain), indicating successful completion of the task.

At (704a), the imaging sensor (110) (e.g., camera) is operated to capture one or more images of the assembled block configuration.

In some examples, the imaging sensor (110) is automatically triggered after a certain time period has elapsed. In other examples, the imaging sensor (110) is only triggered in response to an input by the user (e.g., clicking a button), indicating that the user has completed the coding task. In still other examples, the imaging sensor (110) operates to capture images in real-time, or near real-time, on a continuous or semi-continuous basis (e.g., using a video camera).

At (706a), the learning software analyzes the imaged assembled block configuration, to resolve (or determine) one or more block arrangement features. The determined arrangement features include, (i) the block types in the imaged arrangement; (ii) attributes of these block types (e.g., block attributes); and/or (iii) the coupling configuration of these block types. The coupling configuration refers to which block types, having specific block attributes, are positioned in the apertures of other block types, or otherwise positioned adjacent other block types.

For example, in FIG. 4 the system can determine, (i) the block types include a variable block (402), an operator block (204) and a value bock (202); (ii) the attributes of these block types include the type of operator block (204) being an “=” operator, and the numerical value of the value block (202) being, e.g., “5”; and (iii) the coupling configuration corresponding to the operator and value blocks (202, 204) being received into the apertures of the variable block (402).

In at least one example, at (706a), a trained object detection model is applied, which is able to resolve the arrangement properties. For example, the trained object detection model is able to analyze the imaged block arrangement to classify the different block types, their attributes and their coupling configuration.

In some examples, the object detection model is trained to classify the block types based on their various physical properties. These physical properties include the shape, color, aperture pattern, and aperture shape. The trained object detection model can also be trained to classify block properties and attributes by analyzing the physical indications on the top surface (e.g., Braille indicating operator type or numerical value). Still further, the trained model can be trained to determine the coupling configuration based on the positioning of the classified block types within the apertures of other block types.

At (708a), the system determines a coding structure (or coding representation) associated with the determined arrangement features. For example, in FIG. 5, the system can resolve the block arrangement as corresponding to the logic computational instruction: If (variable X=5) is greater (>) than value=7, then a PRINT function is invoked.

At (710a), it is determined whether the coding structure satisfies one or more task completion criteria. The completion criteria define the conditions under which the coding task is determined to be correctly completed. Accordingly, each coding task is associated with one or more task completion criteria.

In some cases, performing (710a) simply involves determining whether the code structure satisfies the solution coding structure, for the coding task. To that end, each coding task may be generated with its corresponding target coding structure solution, expressed by a particular coding structure. In cases where the task involves multiple code structures, the system can determine if the user arranges the blocks according to each target arrangement associated with each target code structure and in the correct ordered arrangement.

If the determination at (710a) is positive, then at (712a), a positive output is generated (e.g., an audio prompt indicating the task was successfully accomplished). Otherwise, at (714a), a negative output is generated (e.g., requesting the user to try again). More generally, the outputs generated at (712a) and/or (714) can be any form of non-visual output feedback, e.g., audio or physical tactile touch.

In some cases, acts (706a) to (714a) are performed in real-time, or near real-time.

### (ii.) Applying Objection Detection Model.

FIG. 7B shows an example process flow for an example method (700b) for applying a trained object detection model. Method (700b) can be executed as part of act (706a) (FIG. 7A).

In some examples, method (700b) is executed by the processor (902) of the user device (110).

At (702b), the image of the arranged block configuration (e.g., captured at (704a)) is analyzed to extract one or more features. As explained herein, these features are input into a trained objection detection model to determine one or more block arrangement features. In some examples, the one or more features extracted include various shape features, as well as other physical block properties as explained previously.

At (704b), the extracted features are input into the trained object detection model, and the object detection model is applied to predict arrangement features of the imaged blocks, which are then output at (706b).

In some examples, acts (702b) and (704b) are executed using a trained MobileNetSSD model, such as an MobileNetSSDv2 (e.g., PRETRAINED_MODEL_NAME ‘ssd_mobilenet_v2_fpnlite_320×320). This is a two part model, whereby: (i) the first part comprises the base MobileNetV2 network which acts as a feature extractor (702b), and comprises a convolutional neural network (CNN); and (ii) a second part comprising a trained single shot detector (SSD) layer, that classifies objects in the image based on the extracted features. Accordingly, in this example, the trained object detection model can perform both feature extraction and object classification (e.g., (702b) and (704b)).

MobileNetSSD models are known in the art. In particular, the use of a MobileNetV2 for feature extraction may be particularly adapted for the present application. These models are designed to be lightweight and fast while maintaining good accuracy, and therefore optimized for mobile and edge devices used for the on-the-go interactive learning of visually disabled individuals using low cost and affordable hardware (e.g., adapted for hosting and execution on user device (108)).

In other examples, any other model architecture can be trained and used, such as YOLO, other types of convolutional neural network (CNN), as known in the art (e.g., LeNet, VGG-16, VGG-19, and AlexNet).

In some examples, the feature extraction is performed by a processor (902) of the user device (110). The extracted features may then be transmitted to a server (1002) (FIG. 10), to classify the various objects. In other examples, both acts (702b) and (704b) are performed only on the user device (108) and/or on a remote server (1002) (FIG. 10). In the latter case, the remote server (1002) can receive the image captured by the user device (108), and may apply the feature extraction and trained model to the image.

It is appreciated that the use of a trained object detection model allows performing the method 700a (FIG. 7A) which high computational speeds and power, thereby enabling the real time or near real time dynamics necessary for effective learning and teaching.

### (iii.) Example Method of Training Object Detection Model.

FIG. 7C shows a process flow for an example method (700c) for training the object detection model. Method (700c) can be executed by the processor (902), of the user device (108) (FIG. 9). In other examples, method (700c) is executed by a processor of a server (1002) (FIG. 10).

At (702c), various training images of blocks (104) are accessed. The training images can include images of various block types, as described herein.

The training images can also show the blocks coupled together in different assembled block configurations (e.g., FIGS. 3-6). The training images can also image the blocks from various perspective views and angles, as well as different ambient surroundings (e.g., high light versus low light).

In some examples, the training images are pre-captured, and retrieved from stored memory (e.g., a memory of server (1002)). In other examples, the training images are captured by operating the imaging sensor (110) (e.g., camera) of user device (108), to capture one or more images of different block types with different attributes, and assembled block configurations.

At (704c), the training images annotated, by labelling the training images with the various imaged block types. For instance, the training images are labeled based on one or more predefined labels, corresponding to different block types included in the image (e.g., ‘If’, ‘Else’, ‘Print’, ‘Variable’, ‘Value’, ‘Operator’). In at least one example, the images are annotated using “labelImg”, which is a graphical tool designed for this purpose. The annotations can be stored in an XML format.

In some examples, the annotation is performed by a user drawing boxes around the various imaged blocks in a given image (e.g., using an annotation software tool), and manually labelling the boxes with the corresponding block type label (as well as block attributes). The system then stores: (i) the coordinates of the draw boxes, e.g., relative to the image (e.g., corner coordinates); and (ii) the labels associated with each drawing box.

By way of example, a bounding box can have coordinates of (299, 244) for the top-left corner (xₘᵢₙ, yₘᵢₙ), and (428, 313) for the bottom-right corner (xₘₐₓ, yₘₐₓ), whereby:
(xₘᵢₙ) is the x-coordinate of the bounding box's left edge;
(yₘᵢₙ) is the y-coordinate of the bounding box's top edge;
(xₘₐₓ) is the x-coordinate of the bounding box's right edge; and
(yₘₐₓ) is the y-coordinate of the bounding box's bottom edge.

At (706c), the object detection model is trained with the annotated and labelled training images. In at least one example, the training configuration is set up using TensorFlow's Object Detection API. TensorFlow is an open-source machine learning framework by Google®, designed primarily for deep learning. It offers tools for building, training, and deploying models across various platforms, from desktops to mobile devices. The model can be trained using a script in Python from TensorFlow's Object Detection API (e.g., model_main_tf2.py script).

In some examples, the objection detection model comprises an MobileNetSSD model or its variants (e.g., a v2 or v3 model), as explained above. In this example, the model is trained such that it automatically determines which shape features to extract from a labelled image portion (e.g., via training the MobileNetSSD), and uses that to train the SSD layer to classify the block type(s) and block attribute(s) in the image.

As explained below, the training is determined to be completed after the set number of training steps, which is determined to be 8,000 in at least one example.

At (708c), a trained object detection model is output. The trained object detection model may be stored on a memory of server (1002). In other cases, the trained object detection model can be stored on, and/or transmitted (e.g., pushed to, one or more user devices (108).

### IV. Example Training Parameters, Hyper Parameters and Evaluation Metrics for Training Object Detection Model

The following example training parameters were used for training the objection detection model, comprising a MobileNetSSD or its variants (e.g., v2, v3, etc.):
(a) (Batch size=4)—The batch size refers to the number of training samples processed before updating the model's parameters. Smaller batches can help prevent overfitting, while larger ones can speed up training due to better computational efficiency.
(b) (Apply fine-tuning checkpoint)—This involves starting the training process with a model already trained on a broad dataset. This approach helps in applying the learned patterns from the broad data when training on a more specific dataset.
(c) (Number of training steps=8000)—The number of training steps indicates how often the model updates during training. Based on experimentation, it was found that 8,000 was the optimal number of steps for training in this specific context.

The following example hyper parameters were used for controlling the learning process:
(a) (Depth multiplier=1.0)—This is a parameter specific to MobileNets and its variants. The depth multiplier is used to thin the model architecture. A value less than one is used to reduce the number of parameters and computational cost of the model. For instance, a depth multiplier of 0.5 would halve the number of filters in each layer, effectively reducing the model size and computation, but at the potential expense of model accuracy. In our model, a depth multiplier of 1.0 means we are using the base version without thinning.
(b) (Minimum depth=16)—This parameter ensures that even when depth multiplier values are small (less than 1), the number of channels doesn't fall below this minimum depth value. It's a safeguard to prevent layers from becoming too thin when the depth multiplier is applied.

The performance of the trained object detection model was determined using COCO detection evaluation metrics. COCO detection metrics are a standardized set of evaluation criteria used for object detection tasks. These metrics assess the performance of a model by comparing its predictions against ground truth annotations. These metrics provide insights into how well the model performs in terms of both localization (finding the objects) and classification (identifying the objects). The following metrics were evaluated for the trained MobileNetSSD model:
(a) Precision Metrics:
   (mAP (Mean Average Precision)=0.7371)—This is an average of the precision values at different recall levels.
   (mAP (large objects)=0.7732)—This metric specifically evaluates the model's performance on large-sized objects.
   (mAP (medium objects)=0.6592)—This metric assesses the model's ability to detect medium-sized objects.
   (mAP at 0.50; IoU (Intersection over Union)=0.9574)—This evaluates precision when the overlap between the predicted bounding box and the ground truth is at least 50%.
   (mAP at 0.75; IoU=0.8533)—Similar to the above, but at a stricter overlap threshold of 75%.
(b) Recall Metrics:
   (AR@1 (Average Recall at 1 detection per image)=0.6576)—Evaluates the average recall when only one detection is allowed per image.
   (AR@10 (Average Recall at 10 detections per image=0.7843)—Similar to AR@1, but with up to 10 detections allowed per image.
   (AR@100 (Overall Average Recall across all sizes at 100 detections per image=0.7843)—A score of 0.7843 suggests the model has a consistent recall rate across different object sizes.
   (AR@100 (small objects)=0.8225)—Average recall for small-sized objects with up to 100 detections per image.
   (AR@100 (large objects)=0.7446)—For large-sized objects.
(c) Loss:
   (Classification loss=0.1955)—Measures the model's error in identifying the correct classes of the detected objects.
   (Localization loss=0.05233)—Measures the model's error in accurately positioning the bounding boxes around objects.
   (Regularization loss=0.1343)—Penalizes the model for complexity, ensuring it doesn't over fit the training data.
   (Total loss=0.3822)—An aggregate of the above losses, providing an overall measure of the model's error.

Accordingly, the trained object detection model demonstrated high metric performance.

### V. Specific or Alternative Embodiments

In some examples, the learning software—which executes method (700a) in FIG. 7A—is not necessarily hosted on the user device (108), but rather, is hosted on an external server (e.g., cloud server (1002) in FIG. 10). In that case, images from imaging sensor (906) may be transmitted via a network (1005) (e.g., wired or wireless), to the external server for further processing, in accordance with method (700a). Method (700a) is then executed by a processor of the external server. In other cases, method (700a) is executed by processors of multiple computing devices (e.g., user device (108) and/or one or more external servers (1002)).

### VI. Example Hardware Configuration for User Device

Reference is made to FIG. 9, which shows an example hardware configuration for an example user device (108).

As shown, the user device (108) can include a processor (902) coupled to a memory (904) and one or more of: (i) imaging sensor(s) (906), (ii) communication interface (908), (iii) a non-visual output interface (910), and (iv) an input interface (912).

Processor (902) comprises one or more electronic devices that is/are capable of reading and executing instructions stored on a memory (904) to perform operations on data, which may be stored on a memory or provided in a data signal. The term “processor” or “at least one processor” includes a plurality of physically discrete, operatively connected devices despite use of the term in the singular. Non-limiting examples of processors include devices referred to as microprocessors, microcontrollers, central processing units (CPU), and digital signal processors.

Memory (904) can comprise a non-transitory tangible computer-readable medium for storing information in a format readable by a processor, and/or instructions readable by a processor to implement an algorithm. The term “memory” includes a plurality of physically discrete, operatively connected devices despite use of the term in the singular. Non-limiting types of memory include solid-state, optical, and magnetic computer readable media. Memory may be non-volatile or volatile. Instructions stored by a memory may be based on a plurality of programming languages known in the art, with non-limiting examples including the C, C++, Python™, MATLAB™, and Java™ programming languages.

Imaging sensor(s) (906) can include any sensor for capturing two-dimensional (2D) images. For instance, this can be a camera for capturing color images (e.g., Red Green Blue (RGB) camera), grey-scale or black-and-white images.

Communication interface (908) may comprise a cellular modem and antenna for wireless transmission of data to the communications network.

Non-visual output interface (910) is any interface for outputting non-visual outputs. For example, this is an audio speaker to output audio prompts. In other cases, it is a form of tactile haptic output interface (e.g., a Braille display). Input interface (912) can be any interface for receiving user inputs (e.g., buttons).

While not illustrated, user device (108) can also include a display interface (e.g., an LCD screen). In some cases, the display interface and the input interface (912) may be one of the same (e.g., a touchscreen display).

To that end, it will be understood by those of skill in the art that references herein to user device (108) as carrying out a function or acting in a particular way imply that processor (902) is executing instructions (e.g., a software program) stored in memory (904) and possibly transmitting or receiving inputs and outputs via one or more interfaces. In some examples, memory (904) can store the learning software.

In some examples, the user device (108) can be coupled via network (1005) (e.g., wired or wireless network) to an external server (1002) (FIG. 10). The server (1002) may also have a processor coupled to a memory and a communication interface (not shown).

### VII. Interpretation

Various systems or methods have been described to provide an example of an embodiment of the claimed subject matter. No embodiment described limits any claimed subject matter and any claimed subject matter may cover methods or systems that differ from those described below. The claimed subject matter is not limited to systems or methods having all of the features of any one system or method described below or to features common to multiple or all of the apparatuses or methods described below. It is possible that a system or method described is not an embodiment that is recited in any claimed subject matter. Any subject matter disclosed in a system or method described that is not claimed in this document may be the subject matter of another protective instrument, for example, a continuing patent application, and the applicants, inventors or owners do not intend to abandon, disclaim or dedicate to the public any such subject matter by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should also be noted that the terms “coupled” or “coupling” as used herein can have several different meanings depending in the context in which these terms are used. For example, the terms coupled or coupling may be used to indicate that an element or device can electrically, optically, or wirelessly send data to another element or device as well as receive data from another element or device. As used herein, two or more components are said to be “coupled”, or “connected” where the parts are joined or operate together either directly or indirectly (i.e., through one or more intermediate components), so long as a link occurs. As used herein and in the claims, two or more parts are said to be “directly coupled”, or “directly connected”, where the parts are joined or operate together without intervening intermediate components.

It should be noted that terms of degree such as “substantially”, “about” and “approximately” as used herein mean a reasonable amount of deviation of the modified term such that the end result is not significantly changed. These terms of degree may also be construed as including a deviation of the modified term if this deviation would not negate the meaning of the term it modifies.

Furthermore, any recitation of numerical ranges by endpoints herein includes all numbers and fractions subsumed within that range (e.g. 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the end result is not significantly changed.

The example embodiments of the systems and methods described herein may be implemented as a combination of hardware or software. In some cases, the example embodiments described herein may be implemented, at least in part, by using one or more computer programs, executing on one or more programmable devices comprising at least one processing element, and a data storage element (including volatile memory, non-volatile memory, storage elements, or any combination thereof). These devices may also have at least one input device (e.g. a pushbutton keyboard, mouse, a touchscreen, and the like), and at least one output device (e.g. a display screen, a printer, a wireless radio, and the like) depending on the nature of the device.

It should also be noted that there may be some elements that are used to implement at least part of one of the embodiments described herein that may be implemented via software that is written in a high-level computer programming language such as object oriented programming or script-based programming. Accordingly, the program code may be written in Java, Swift/Objective-C, C, C++, Javascript, Python, SQL or any other suitable programming language and may comprise modules or classes, as is known to those skilled in object oriented programming. Alternatively, or in addition thereto, some of these elements implemented via software may be written in assembly language, machine language or firmware as needed. In either case, the language may be a compiled or interpreted language.

At least some of these software programs may be stored on a storage media (e.g. a computer readable medium such as, but not limited to, ROM, magnetic disk, optical disc) or a device that is readable by a general or special purpose programmable device. The software program code, when read by the programmable device, configures the programmable device to operate in a new, specific and predefined manner in order to perform at least one of the methods described herein.

Furthermore, at least some of the programs associated with the systems and methods of the embodiments described herein may be capable of being distributed in a computer program product comprising a computer readable medium that bears computer usable instructions for one or more processors. The medium may be provided in various forms, including non-transitory forms such as, but not limited to, one or more diskettes, compact disks, tapes, chips, and magnetic and electronic storage. The computer program product may also be distributed in an over-the-air or wireless manner, using a wireless data connection.

The term “software application” or “application” refers to computer-executable instructions, particularly computer-executable instructions stored in a non-transitory medium, such as a non-volatile memory, and executed by a computer processor. The computer processor, when executing the instructions, may receive inputs and transmit outputs to any of a variety of input or output devices to which it is coupled. Software applications may include mobile applications or “apps” for use on mobile devices such as smartphones and tablets or other “smart” devices.

A software application can be, for example, a monolithic software application, built in-house by the organization and possibly running on custom hardware; a set of interconnected modular subsystems running on similar or diverse hardware; a software-as-a-service application operated remotely by a third party; third party software running on outsourced infrastructure, etc. In some cases, a software application also may be less formal, or constructed in ad hoc fashion, such as a programmable spreadsheet document that has been modified to perform computations for the organization's needs.

Software applications may be deployed to and installed on a computing device on which it is to operate. Depending on the nature of the operating system and/or platform of the computing device, an application may be deployed directly to the computing device, and/or the application may be downloaded from an application marketplace. For example, user of the user device may download the application through an app store such as the Apple App Store™ or Google™ Play™.

The present invention has been described here by way of example only, while numerous specific details are set forth herein in order to provide a thorough understanding of the exemplary embodiments described herein. However, it will be understood by those of ordinary skill in the art that these embodiments may, in some cases, be practiced without these specific details. In other instances, well-known methods, procedures and components have not been described in detail so as not to obscure the description of the embodiments. Various modification and variations may be made to these exemplary embodiments without departing from the spirit and scope of the invention, which is limited only by the appended claims.

1. A method for performing coding tasks using physical toy blocks, comprising:
capturing at least one image of an assembled arrangement of the toy blocks,
wherein each toy block comprises a block type associated with a programming code concept;
analyzing the at least one image to determine one or more block arrangement features;
based on the determined arrangement features, determining a coding structure associated with the block arrangement;
determining if the coding structure satisfies one or more task completion criteria, associated with a coding task; and
if so, generating an output indicating the coding task is completed.

2. The method of claim 1, wherein the analyzing of the images is performed using a trained object detection model.

3. The method of claim 2, wherein the trained object detection model is a trained MobileNetSSD model.

4. The method of claim 1, wherein the programming code concept comprises one or more syntax elements of a logic computational instruction, and the coding structure comprises the logic computational instruction.

5. The method of claim 4, wherein the programming code concept comprises one or more of a numerical value, a variable, a data type, an operator, a control flow statement or an action.

6. The method of claim 1, wherein the block arrangement features include one or more of (i) the block types in the arrangement; (ii) block attributes of each block type; and (iii) coupling configuration of the toy blocks.

7. The method of claim 1, wherein a coding task comprises instructions to physically arrange the toy blocks in a target assembled configuration corresponding to a target coding structure.

8. The method of claim 7, wherein determining if the task completion criteria are satisfied comprises determining that the coding structure associated with the block arrangement, matches the target coding structure.

9. The method of claim 1, wherein the output comprises non-visual feedback.

10. The method of claim 9, wherein the non-visual feedback comprises an audio prompt or a haptic prompt.

11. An interactive system for performing coding tasks using physical toy blocks, comprising:
a plurality of toy blocks, each toy block being of a block type that is associated with a programming code concept;
an imaging sensor;
a non-visual interface for communicating an output; and
at least one processor coupled to the imaging sensor and configured for:
capturing, using the imaging sensor, at least one image of an assembled arrangement of the toy blocks in the plurality of toy blocks,
analyzing the at least one image to determine one or more block arrangement features;
based on the determined arrangement features, determining a coding structure associated with the block arrangement;
determining if the coding structure satisfies one or more task completion criteria, associated with a coding task; and
if so, generating an output indicating the coding task is completed via the non-visual interface.

12. The system of claim 11, wherein the analyzing of the images is performed using a trained object detection model.

13. The system of claim 12, wherein the trained object detection model is a trained MobileNetSSD model.

14. The system of claim 11, wherein the programming code concept comprises one or more syntax elements of a logic computational instruction, and the coding structure comprises the logic computational instruction.

15. The system of claim 14, wherein the programming code concept comprise one or more of a numerical value, a variable, a data type, an operator, a control flow statement or an action.

16. The system of claim 11, wherein the block arrangement features include one or more of (i) the block types in the arrangement; (ii) block attributes of each block type; and (iii) coupling configuration of the toy blocks.

17. The system of claim 11, wherein a coding task comprises instructions to physically arrange the toy blocks in a target assembled configuration corresponding to a target coding structure.

18. The system of claim 17, wherein determining if the task completion criteria are satisfied comprises determining that the coding structure associated with the block arrangement, matches the target coding structure.

19. The system of claim 11, wherein the output comprises non-visual feedback.

20. The system of claim 19, wherein the non-visual feedback comprises an audio prompt or a haptic prompt.
